(19) United States
(12) Patent Application Publication
(10) Pub. No.: US 2013/0178566 A1
(43) Pub. Date: Jul. 11, 2013

(54) RUBBER MIXTURES

(71) Applicant: EVONIK INDUSTRIES AG, Essen (DE)

(72) Inventors: Anke BLUME, Weilerswist (DE); Eugenie KARASEWITSCH, Uelzen (DE)

(73) Assignee: EVONIK INDUSTRIES AG, Essen (DE)

(21) Appl. No.: 13/734,494

(22) Filed: Jan. 4, 2013

(30) Foreign Application Priority Data
Jan. 6, 2012 (DE) 10 2012 200 166.2

(51) Int. Cl. C08L 13/00

(52) U.S. Cl. CPC C08L 13/00
USPC 524/114

(57) ABSTRACT

The invention relates to rubber mixtures comprising
(A) at least one polyacrylate rubber,
(B) at least one silicatic or oxidic filler or carbon black and
(C) at least one epoxysilane.

The rubber mixtures can be used to produce mouldings.

The invention relates to rubber mixtures, production thereof and use thereof.

Vulcanizable rubber mixtures based on polyacrylate elastomers have been disclosed in “High-Performance HT-ACMs for automotive moulded and extruded applications”, Rubber World October 2007, pp. 46-54.

The known rubber mixtures comprising polyacrylate elastomer has disadvantageous poor dynamic properties.

It is an object according to the invention to provide rubber mixtures which comprise polyacrylate elastomer and which has improved dynamic properties.

The invention provides rubber mixtures characterized in that they comprise

(A) at least one polyacrylate rubber,
(B) at least one silicatic or oxidic filler or carbon black and
(C) at least one epoxysilane.

The epoxysilane can preferably comprise at least one alkoxy- or alkylpolyether group.

Epoxysilanes can be epoxysilanes of the formula I

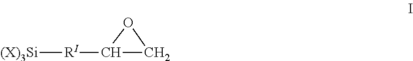

where
X are mutually independently an alkylpolyether group O—((CR^{II}₂)_{w}—O—)ₜAlk, branched or unbranched alkyl, preferably C₁-C₁₈ alkyl, particularly preferably —CH₃, —CH₂—CH₃, —CH(CH₃)—CH₃, —CH₂—CH₂—CH₃ or C₄-C₁₈ alkyl, branched or unbranched alkoxy, preferably branched or unbranched C₁-C₂₂ alkoxy, particularly preferably —OCH₃, —OCH₂—CH₃, —OCH(CH₃)—CH₃, —OCH₂—CH₂—CH₃, —OC₉H₁₉, —OC₁₀H₂₁, —OC₁₁H₂₃, —OC₁₂H₂₅, —OC₁₃H₂₇, —OC₁₄H₂₉, —OC₁₅H₃₁, —OC₁₆H₃₃, —OC₁₇H₃₅ or —OC₁₈H₃₇,
branched or unbranched C₂-C₂₅ alkenyloxy, preferably C₄-C₂₀ alkenyloxy, particularly preferably C₆-C₁₈ alkenyloxy,
C₆-C₃₅ aryloxy, preferably C₉-C₃₀ aryloxy, particularly preferably phenyloxy (—OC₆H₅) or C₉-C₁₈ aryloxy, a branched or unbranched C₇-C₃₅ alkylaryloxy group, preferably C₉-C₃₀ alkylaryloxy group, particularly preferably benzyloxy, —O—CH₂—C₆H₅ or —O—CH₂—CH₂—C₆H₅, or a branched or unbranched C₇-C₃₅ aralkyloxy group, preferably C₉-C₂₅ aralkyloxy group, particularly preferably tolyloxy (—O—C₆H₄—CH₃) or a C₉-C₁₈ aralkyloxy group,
where R^{II} are mutually independently H, a phenyl group or an alkyl group,
w=from 2 to 20, preferably from 2 to 17, particularly preferably from 2 to 15, very particularly preferably from 2 to 13, exceptionally preferably from 2 to 10,
t=from 2 to 20, preferably from 3 to 17, particularly preferably from 3 to 15, very particularly preferably from 4 to 15, exceptionally preferably from 4 to 10, Alk is a branched or unbranched, saturated or unsaturated, substituted or unsubstituted, aliphatic, aromatic or mixed aliphatic/aromatic monovalent hydrocarbon group having more than 6 carbon atoms, preferably C₇-C₂₅—, particularly preferably C₈-C₂₂—, very particularly preferably C₈-C₁₇—, exceptionally preferably C₁₁-C₁₆—, hydrocarbon group,
R^{I} is a branched or unbranched, saturated or unsaturated, aliphatic, aromatic or mixed aliphatic/aromatic divalent C₁-C₃₀ hydrocarbon group which optionally has substitution, or a divalent alkyl ether group.

The group (CR^{II}₂)_{w} can be —CH₂—CH₂—, —CH₂—CH(CH₃)—, —CH(CH₃)—CH₂—, —CH₂—CH₂—CH₂—CH₂—, —CH₂—CH(—CH₂—CH₃)—, —CH₂—CH(—CH═CH₂)—, —CH₂—CH₂—CH₂—CH₂—CH₂—, —CH₂—CH₂—CH₂—CH₂—CH₂—CH₂—, —CH(C₆H₅)—CH₂— or —CH₂—CH(C₆H₅)—.

R^{I} can be —CH₂—, —CH₂CH₂—, —CH₂CH₂CH₂—, —CH₂CH₂CH₂CH₂—, —CH(CH₃)—, —CH₂CH(CH₃)—, —CH(CH₃)CH₂—, —C(CH₃)₂—, —CH(C₂H₅)—, —CH₂CH₂CH(CH₃)—, —CH₂(CH₃)CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH₂CH₂CH₂CH₂CH₂—, —CH₂CH₂CH₂CH₂CH₂CH₂H₂CH₂—, —CH₂CH₂CH₂CH₂CH₂CH₂CH₂CH₂CH₂—, —CH₂CH₂CH₂CH₂CH₂CH₂CH₂CH₂CH₂CH₂—, —CH₂CH₂H₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂—, —CH₂—O—CH₂—, —CH₂—O—CH₂CH₂—, —CH₂CH₂—O—CH₂—, —CH₂CH₂CH₂—O—CH₂—, —CH₂—O—CH₂CH₂CH₂—, —CH₂CH₂—O—CH₂CH₂—, —CH₂CH₂—O—CH₂CH₂CH₂—, —CH₂CH₂CH₂—O—CH₂CH₂—

or

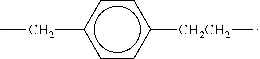

The alkylpolyether group O—((CR^{II}₂)_{w}—O—)ₜ Alk can be O—(CR^{II}₂—CR^{II}₂—CR^{II}₂—)ₜ-Alk, O—(CR^{II}₂—CR^{II}₂—CR^{II}₂—CR^{II}₂—O)ₜ-Alk, preferably O—(—CH₂—CH₂—CH₂—CH₂—)ₜ-Alk, or O—(CR^{II}₂—CR^{II}₂—CR^{II}₂—CR^{II}₂—CR^{II}₂—O)ₜ-Alk.

The alkylpolyether group O—((CR^{II}₂)_{w}—O—)ₜ Alk can be O—(CR^{II}₂—CR^{II}₂—O)ₜ-Alk.

The group O—(CR^{II}₂—CR^{II}₂—O)ₜ-Alk can preferably comprise ethylene oxide units, O—(CH₂—CH₂—O)ₜ-Alk, propylene oxide units, for example O—(CH(CH₃)—CH₂—O)ₜ-Alk or O—(CH₂—CH(CH₃)₂—O)ₜ-Alk, or butylene oxide units, for example O—(—CH(CH₂—CH₃)—CH₂—O)ₜ-Alk or O—(—CH₂—CH(CH₂—CH₃)—O)ₜ-Alk.

Epoxysilanes of the general formula I can be:

[(C₇H₁₅O—(CH₂—CH₂O)₂](Me)₂Si(CH₂)₃—O—CH₂—CH(O)CH₂, [(C₇H₁₅O—(CH₂—CH₂O)₃](Me)₂Si(CH₂)₃—O—CH₂—CH(O)CH₂, [(C₇H₁₅O—(CH₂—CH₂O)₄](Me)₂Si(CH₂)₃—O—CH₂—CH(O)CH₂, [(C₇H₁₅O—(CH₂—CH₂O)₅](Me)₂Si(CH₂)₃—O—CH₂—CH(O)CH₂, [(C₇H₁₅O—(CH₂—CH₂O)₆](Me)₂Si(CH₂)₃—O—CH₂—CH(O)CH₂,
[(C₈H₁₇O—(CH₂—CH₂O)₂](Me)₂Si(CH₂)₃—O—CH₂—CH(O)CH₂, [(C₈H₁₇O—(CH₂—CH₂O)₃](Me)₂Si(CH₂)₃—O—CH₂—CH(O)CH₂, [(C₈H₁₇O—(CH₂—CH₂O)₄](Me)₂Si(CH₂)₃—O—CH₂—CH(O)CH₂, [(C₈H₁₇O—(CH₂—CH₂O)₅](Me)₂Si(CH₂)₃—O—CH₂—CH(O)CH₂, [(C₈H₁₇O—(CH₂—CH₂O)₆](Me)₂Si(CH₂)₃—O—CH₂—CH(O)CH₂,
[(C₉H₁₉O—(CH₂—CH₂O)₂](Me)₂Si(CH₂)₃—O—CH₂—CH(O)CH₂, [(C₉H₁₉O—(CH₂—CH₂O)₃](Me)₂Si(CH₂)₃—O—CH₂—CH(O)CH₂, [(C₉H₁₉O—(CH₂—CH₂O)₄](Me)₂Si(CH₂)₃—O—CH₂—CH(O)CH₂, [(C₉H₁₉O—(CH₂—CH₂O)₅](Me)₂Si(CH₂)₃—O—CH₂—CH(O)CH₂, [(C₉H₁₉O—(CH₂—CH₂O)₆](Me)₂Si(CH₂)₃—O—CH₂—CH(O)CH₂,
[(C₇H₁₅O—(CH₂—CH₂O)₂]₂(Me)Si(CH₂)₃—O—CH₂—CH(O)CH₂, [(C₇H₁₅O—(CH₂—CH₂O)₃]₂(Me)Si(CH₂)₃—O—CH₂—CH(O)CH₂, [(C₇H₁₅O—(CH₂—CH₂O)₄]₂(Me)Si(CH₂)₃—O—CH₂—CH(O)CH₂, [(C₇H₁₅O—(CH₂—CH₂O)₅]₂(Me)Si(CH₂)₃—O—CH₂—CH(O)CH₂, [(C₇H₁₅O—(CH₂—CH₂O)₆]₂(Me)Si(CH₂)₃—O—CH₂—CH(O)CH₂,
[(C₈H₁₇O—(CH₂—CH₂O)₂]₂(Me)Si(CH₂)₃—O—CH₂—CH(O)CH₂, [(C₈H₁₇O—(CH₂—CH₂O)₃]₂(Me)Si(CH₂)₃—O—CH₂—CH(O)CH₂, [(C₈H₁₇O—(CH₂—CH₂O)₄]₂(Me)Si(CH₂)₃—O—CH₂—CH(O)CH₂, [(C₈H₁₇O—(CH₂—CH₂O)₅]₂(Me)Si(CH₂)₃—O—CH₂—CH(O)CH₂, [(C₈H₁₇O—(CH₂—CH₂O)₆]₂(Me)Si (H₂)₃—H₂—CH(O)CH₂,
[(C₉H₁₉O—(CH₂—CH₂O)₂]₂(Me)Si(CH₂)₃—O—CH₂—CH(O)CH₂, [(C₉H₁₉O—(CH₂—CH₂O)₃]₂(Me)Si(CH₂)₃—O—CH₂—CH(O)CH₂, [(C₉H₁₉O—(CH₂—CH₂O)₄]₂(Me)Si(CH₂)₃—O—CH₂—CH(O)CH₂, [(C₉H₁₉O—(CH₂—CH₂O)₅]₂(Me)Si(CH₂)₃—O—CH₂—CH(O)CH₂, [(C₉H₁₉O—(CH₂—CH₂O)₆]₂(Me)Si(CH₂)₃—O—CH₂—CH(O)CH₂,
[(C₇H₁₅O—(CH₂—CH₂O)₂](Me)(EtO)Si(CH₂)₃—O—CH₂—CH(O)CH₂, [(C₇H₁₅O—(CH₂—CH₂O)₃](Me)(EtO)Si(CH₂)₃—O—CH₂—CH(O)CH₂, [(C₇H₁₅O—(CH₂—CH₂O)₄](Me)(EtO)Si(CH₂)₃—O—CH₂—CH(O)CH₂, [(C₇H₁₅O—(CH₂—CH₂O)₅](Me)(EtO)Si(CH₂)₃—O—CH₂—CH(O)CH₂, [(C₇H₁₅O—(CH₂—CH₂O)₆](Me)(EtO)Si(CH₂)₃—O—CH₂—CH(O)CH₂,
[(C₈H₁₇O—(CH₂—CH₂O)₂](Me)(EtO)Si(CH₂)₃—O—CH₂—CH(O)CH₂, [(C₈H₁₇O—(CH₂—CH₂O)₃](Me)(EtO)Si(CH₂)₃—O—CH₂—CH(O)CH₂, [(C₈H₁₇O—(CH₂—CH₂O)₄](Me)(EtO)Si(CH₂)₃—O—CH₂—CH(O)CH₂, [(C₈H₁₇O—(CH₂—CH₂O)₅](Me)(EtO)Si(CH₂)₃—O—CH₂—CH(O)CH₂, [(C₈H₁₇O—(CH₂—CH₂O)₆](Me)(EtO)Si(CH₂)₃—O—CH₂—CH(O)CH₂,
[(C₉H₁₉O—(CH₂—CH₂O)₂](Me)(EtO)Si(CH₂)₃—O—CH₂—CH(O)CH₂, [(C₉H₁₉O—(CH₂—CH₂O)₃](Me)(EtO)Si(CH₂)₃—O—CH₂—CH(O)CH₂, [(C₉H₁₉O—(CH₂—CH₂O)₄](Me)(EtO)Si(CH₂)₃—O—CH₂—CH(O)CH₂, [(C₉H₁₉O—(CH₂—CH₂O)₅](Me)(EtO)Si(CH₂)₃—O—CH₂—CH(O)CH₂, [(C₉H₁₉O—(CH₂—CH₂O)₆](Me)(EtO)Si(CH₂)₃—O—CH₂—CH(O)CH₂,
[(C₁₀H₂₁O—(CH₂—CH₂O)₂](Me)(EtO)Si(CH₂)₃—O—CH₂—CH(O)CH₂, [(C₁₀H₂₁O—(CH₂—CH₂O)₃](Me)(EtO)Si(CH₂)₃—O—CH₂—CH(O)CH₂, [(C₁₀H₂₁O—(CH₂—CH₂O)₄](Me)(EtO)Si(CH₂)₃—O—CH₂—CH(O)CH₂, [(C₁₀H₂₁O—(CH₂—CH₂O)₅](Me)(EtO)Si(CH₂)₃—O—CH₂—CH(O)CH₂, [(C₁₀H₂₁O—(CH₂—CH₂O)₆](Me)(EtO)Si(CH₂)₃—O—CH₂—CH(O)CH₂,
[(C₁₁H₂₃O—(CH₂—CH₂O)₂](Me)(EtO)Si(CH₂)₃—O—CH₂—CH(O)CH₂, [(C₁₁H₂₃O—(CH₂—CH₂O)₃](Me)(EtO)Si(CH₂)₃—O—CH₂—CH(O)CH₂, [(C₁₁H₂₃O—(CH₂—CH₂O)₄](Me)(EtO)Si(CH₂)₃—O—CH₂—CH(O)CH₂, [(C₁₁H₂₃O—(CH₂—CH₂O)₅](Me)(EtO)Si(CH₂)₃—O—CH₂—CH(O)CH₂, [(C₁₁H₂₃O—(CH₂—CH₂O)₆](Me)(EtO)Si(CH₂)₃—O—CH₂—CH(O)CH₂,
[(C₁₂H₂₅O—(CH₂—CH₂O)₂](Me)(EtO)Si(CH₂)₃—O—CH₂—CH(O)CH₂, [(C₁₂H₂₅O—(CH₂—CH₂O)₃](Me)(EtO)Si(CH₂)₃—O—CH₂—CH(O)CH₂, [(C₁₂H₂₅O—(CH₂—CH₂O)₄](Me)(EtO)Si(CH₂)₃—O—CH₂—CH(O)CH₂, [(C₁₂H₂₅O—(CH₂—CH₂O)₅](Me)(EtO)Si(CH₂)₃—O—CH₂—CH(O)CH₂, [(C₁₂H₂₅O—(CH₂—CH₂O)₆](Me)(EtO)Si(CH₂)₃—O—CH₂—CH(O)CH₂,
[(C₁₃H₂₇O—(CH₂—CH₂O)₂](Me)(EtO)Si(CH₂)₃—O—CH₂—CH(O)CH₂, [(C₁₃H₂₇O—(CH₂—CH₂O)₃](Me)(EtO)Si(CH₂)₃—O—CH₂—CH(O)CH₂, [(C₁₃H₂₇O—(CH₂—CH₂O)₄](Me)(EtO)Si(CH₂)₃—O—CH₂—CH(O)CH₂, [(C₁₃H₂₇O—(CH₂—CH₂O)₅](Me)(EtO)Si(CH₂)₃—O—CH₂—CH(O)CH₂, [(C₁₃H₂₇O—(CH₂—CH₂O)₆](Me)(EtO)Si(CH₂)₃—O—CH₂—CH(O)CH₂,
[(C₁₄H₂₉O—(CH₂—CH₂O)₂](Me)(EtO)Si(CH₂)₃—O—CH₂—CH(O)CH₂, [(C₁₄H₂₉O—(CH₂—CH₂O)₃](Me)(EtO)Si(CH₂)₃—O—CH₂—CH(O)CH₂, [(C₁₄H₂₉O—(CH₂—CH₂O)₄](Me)(EtO)Si(CH₂)₃—O—CH₂—CH(O)CH₂, [(C₁₄H₂₉O—(CH₂—CH₂O)₅](Me)(EtO)Si(CH₂)₃—O—CH₂—CH(O)CH₂, [(C₁₄H₂₉O—(CH₂—CH₂O)₆](Me)(EtO)Si(CH₂)₃—O—CH₂—CH(O)CH₂,
[(C₁₅H₃₁O—(CH₂—CH₂O)₂](Me)(EtO)Si(CH₂)₃—O—CH₂—CH(O)CH₂, [(C₁₅H₃₁O—(CH₂—CH₂O)₃](Me)(EtO)Si(CH₂)₃—O—CH₂—CH(O)CH₂, [(C₁₅H₃₁O—(CH₂—CH₂O)₄](Me)(EtO)Si(CH₂)₃—O—CH₂—CH(O)CH₂, [(C₁₅H₃₁O—(CH₂—CH₂O)₅](Me)(EtO)Si(CH₂)₃—O—CH₂—CH(O)CH₂, [(C₁₅H₃₁O—(CH₂—CH₂O)₆](Me)(EtO)Si(CH₂)₃—O—CH₂—CH(O)CH₂,
[(C₁₆H₃₃O—(CH₂—CH₂O)₂](Me)(EtO)Si(CH₂)₃—O—CH₂—CH(O)CH₂, [(C₁₆H₃₃O—(CH₂—CH₂O)₃](Me)(EtO)Si(CH₂)₃—O—CH₂—CH(O)CH₂, [(C₁₆H₃₃O—(CH₂—CH₂O)₄](Me)(EtO)Si(CH₂)₃—O—CH₂—CH(O)CH₂, [(C₁₆H₃₃O—(CH₂—CH₂O)₅](Me)(EtO)Si(CH₂)₃—O—CH₂—CH(O)CH₂, [(C₁₆H₃₃O—(CH₂—CH₂O)₆](Me)(EtO)Si(CH₂)₃—O—CH₂—CH(O)CH₂,
[(C₁₇H₃₅O—(CH₂—CH₂O)₂](Me)(EtO)Si(CH₂)₃—O—CH₂—CH(O)CH₂, [(C₁₇H₃₅O—(CH₂—CH₂O)₃](Me)(EtO)Si(CH₂)₃—O—CH₂—CH(O)CH₂, [(C₁₇H₃₅O—(CH₂—CH₂O)₄](Me)(EtO)Si(CH₂)₃—O—H₂—CH(O)CH₂, [(C₁₇H₃₅O—(CH₂—CH₂O)₅](Me)(EtO)Si(CH₂)₃—O—CH₂—CH(O)CH₂, [(C₁₇H₃₅O—(CH₂—CH₂O)₆](Me)(EtO)Si(CH₂)₃—O—CH₂—CH(O)CH₂,
[(C₁₈H₃₇O—(CH₂—CH₂O)₂](Me)(EtO)Si(CH₂)₃—O—CH₂—CH(O)CH₂, [(C₁₈H₃₇O—(CH₂—CH₂O)₃](Me)(EtO)Si(CH₂)₃—O—CH₂—CH(O)CH₂, [(C₁₈H₃₇O—(CH₂—CH₂O)₄](Me)(EtO)Si(CH₂)₃—O—CH₂—CH(O)CH₂, [(C₁₈H₃₇O—(CH₂—CH₂O)₅](Me)(EtO)Si(CH₂)₃—O—CH₂—CH(O)CH₂, [(C₁₈H₃₇O—(CH₂—CH₂O)₆](Me)(EtO)Si(CH₂)₃—O—CH₂—CH(O)CH₂,
[(C₇H₁₅O—(CH₂—CH₂O)₂](Me)(MeO)Si(CH₂)₃—O—CH₂—CH(O)CH₂, [(C₇H₁₅O—(CH₂—CH₂O)₃](Me)(MeO)Si(CH₂)₃—O—CH₂—CH(O)CH₂, [(C₇H₁₅O—(CH₂—CH₂O)₄](Me)(MeO)Si(CH₂)₃—O—CH₂—CH(O)CH₂, [(C₇H₁₅O—(CH₂—CH₂O)₅](Me)(MeO)Si(CH₂)₃—O—CH₂—CH(O)CH₂, [(C₇H₁₅O—(CH₂—CH₂O)₆](Me)(MeO)Si(CH₂)₃—O—CH₂—CH(O)CH₂,
[(C₈H₁₇O—(CH₂—CH₂O)₃](Me)(MeO)Si(CH₂)₃—O—CH₂—CH(O)CH₂, [(C₈H₁₇O—(CH₂—CH₂O)₄](Me)(MeO)Si(CH₂)₃—O—CH₂—CH(O)CH₂, [(C₈H₁₇O—(CH₂—CH₂O)₅](Me)(MeO)Si(CH₂)₃—O—CH₂—CH(O)CH₂, [(C₈H₁₇—(CH₂—CH₂O)₆](Me)(MeO)Si(CH₂)₃—O—CH₂—CH(O)CH₂,
[(C₉H₁₉O—(CH₂—CH₂O)₂](Me)(MeO)Si(CH₂)₃—O—CH₂—CH(O)CH₂, [(C₉H₁₉O—(CH₂—CH₂O)₃](Me)(MeO)Si(CH₂)₃—O—CH₂—CH(O)CH₂, [(C₉H₁₉O—(CH₂—CH₂O)₄](Me)(MeO)Si(CH₂)₃—O—CH₂—CH(O)CH₂, [(C₉H₁₉O—(CH₂—CH₂O)₅](Me)(MeO)Si(CH₂)₃—O—CH₂—CH(O)CH₂, [(C₉H₁₉O—(CH₂—CH₂O)₆](Me)(MeO)Si(CH₂)₃—O—CH₂—CH(O)CH₂,
[(C₇H₁₅O—(CH₂—CH₂O)₂](MeO)₂Si(CH₂)₃—O—CH₂—CH(O)CH₂, [(C₇H₁₅O—(CH₂—CH₂O)₃](MeO)₂Si(CH₂)₃—O—CH₂—CH(O)CH₂, [(C₇H₁₅O—(CH₂—CH₂O)₄](MeO)₂Si(CH₂)₃—O—CH₂—CH(O)CH₂, [(C₇H₁₅O—(CH₂—CH₂O)₅](MeO)₂Si(CH₂)₃—O—CH₂—CH(O)CH₂, [(C₇H₁₅O—(CH₂—CH₂O)₆](MeO)₂Si(CH₂)₃—O—CH₂—CH(O)CH₂,
[(C₈H₁₇O—(CH₂—CH₂O)₂](MeO)₂Si(CH₂)₃—O—CH₂—CH(O)CH₂, [(C₈H₁₇O—(CH₂—CH₂O)₃](MeO)₂Si(CH₂)₃—O—CH₂—CH(O)CH₂, [(C₈H₁₇O—(CH₂—CH₂O)₄](MeO)₂Si(CH₂)₃—O—CH₂—CH(O)CH₂, [(C₈H₁₇O—(CH₂—CH₂O)₅](MeO)₂Si(CH₂)₃—O—CH₂—CH(O)CH₂, [(C₈H₁₇O—(CH₂—CH₂O)₆](MeO)₂Si(CH₂)₃—O—CH₂—CH(O)CH₂,
[(C₉H₁₉O—(CH₂—CH₂O)₂](MeO)₂Si(CH₂)₃—O—CH₂—CH(O)CH₂, [(C₉H₁₉O—(CH₂—CH₂O)₃](MeO)₂Si(CH₂)₃—O—CH₂—CH(O)CH₂, [(C₉H₁₉O—(CH₂—CH₂O)₄](MeO)₂Si(CH₂)₃—O—CH₂—CH(O)CH₂, [(C₉H₁₉O—(CH₂—CH₂O)₅](MeO)₂Si(CH₂)₃—O—CH₂—CH(O)CH₂, [(C₉H₁₉O—(CH₂—CH₂O)₆](MeO)₂Si(CH₂)₃—O—CH₂—CH(O)CH₂,
[(C₁₀H₂₁O—(CH₂—CH₂O)₂](MeO)₂Si(CH₂)₃—O—CH₂—CH(O)CH₂, [(C₁₀H₂₁O—(CH₂—CH₂O)₃](MeO)₂Si(CH₂)₃—O—CH₂—CH(O)CH₂, [(C₁₀H₂₁O—(CH₂—CH₂O)₄](MeO)₂Si(CH₂)₃—O—CH₂—CH(O)CH₂, [(C₁₀H₂₁O—(CH₂—CH₂O)₅](MeO)₂Si(CH₂)₃—O—CH₂—CH(O)CH₂, [(C₁₀H₂₁O—(CH₂—CH₂O)₆](MeO)₂Si(CH₂)₃—O—CH₂—CH(O)CH₂,
[(C₁₁H₂₃O—(CH₂—CH₂O)₂](MeO)₂Si(CH₂)₃—O—CH₂—CH(O)CH₂, [(C₁₁H₂₃O—(CH₂—CH₂O)₃](MeO)₂Si(CH₂)₃—O—CH₂—CH(O)CH₂, [(C₁₁H₂₃O—(CH₂—CH₂O)₄](MeO)₂Si(CH₂)₃—O—CH₂—CH(O)CH₂, [(C₁₁H₂₃O—(CH₂—CH₂O)₅](MeO)₂Si(CH₂)₃—O—CH₂—CH(O)CH₂, [(C₁₁H₂₃O—(CH₂—CH₂O)₆](MeO)₂Si(CH₂)₃—O—CH₂—CH(O)CH₂,
[(C₁₂H₂₅O—(CH₂—CH₂O)₂](MeO)₂Si(CH₂)₃—O—CH₂—CH(O)CH₂, [(C₁₂H₂₅O—(CH₂—CH₂O)₃](MeO)₂Si(CH₂)₃—O—CH₂—CH(O)CH₂, [(C₁₂H₂₅O—(CH₂—CH₂O)₄](MeO)₂Si(CH₂)₃—O—CH₂—CH(O)CH₂, [(C₁₂H₂₅O—(CH₂—CH₂O)₅](MeO)₂Si(CH₂)₃—O—CH₂—CH(O)CH₂, [(C₁₂H₂₅O—(CH₂—CH₂O)₆](MeO)₂Si(CH₂)₃—O—CH₂—CH(O)CH₂,
[(C₁₃H₂₇O—(CH₂—CH₂O)₂](MeO)₂Si(CH₂)₃—O—CH₂—CH(O)CH₂, [(C₁₃H₂₇O—(CH₂—CH₂O)₃](MeO)₂Si(CH₂)₃—O—CH₂—CH(O)CH₂, [(C₁₃H₂₇O—(CH₂—CH₂O)₄](MeO)₂Si(CH₂)₃—O—CH₂—CH(O)CH₂, [(C₁₃H₂₇O—(CH₂—CH₂O)₅](MeO)₂Si(CH₂)₃—O—CH₂—CH(O)CH₂, [(C₁₃H₂₇O—(CH₂—CH₂O)₆](MeO)₂Si(CH₂)₃—O—CH₂—CH(O)CH₂,
[(C₁₄H₂₉O—(CH₂—CH₂O)₂](MeO)₂Si(CH₂)₃—O—CH₂—CH(O)CH₂, [(C₁₄H₂₉O—(CH₂—CH₂O)₃](MeO)₂Si(CH₂)₃—O—CH₂—CH(O)CH₂, [(C₁₄H₂₉O—(CH₂—CH₂O)₄](MeO)₂Si(CH₂)₃—O—CH₂—CH(O)CH₂, [(C₁₄H₂₉O—(CH₂—CH₂O)₅](MeO)₂Si(CH₂)₃—O—CH₂—CH(O)CH₂, [(C₁₄H₂₉O—(CH₂—CH₂O)₆](MeO)₂Si(CH₂)₃—O—CH₂—CH(O)CH₂,
[(C₁₆H₃₃O—(CH₂—CH₂O)₂](MeO)₂Si(CH₂)₃—O—CH₂—CH(O)CH₂, [(C₁₆H₃₃O—(CH₂—CH₂O)₃](MeO)₂Si(CH₂)₃—O—CH₂—CH(O)CH₂, [(C₁₆H₃₃O—(CH₂—CH₂O)₄](MeO)₂Si(CH₂)₃—O—CH₂—CH(O)CH₂, [(C₁₆H₃₃O—(CH₂—CH₂O)₅](MeO)₂Si(CH₂)₃—O—CH₂—CH(O)CH₂, [(C₁₆H₃₃O—(CH₂—CH₂O)₆](MeO)₂Si(CH₂)₃—O—CH₂—CH(O)CH₂,
[(C₁₈H₃₇O—(CH₂—CH₂O)₂](MeO)₂Si(CH₂)₃—O—CH₂—CH(O)CH₂, [(C₁₈H₃₇O—(CH₂—CH₂O)₃](MeO)₂Si(CH₂)₃—O—CH₂—CH(O)CH₂, [(C₁₈H₃₇O—(CH₂—CH₂O)₄](MeO)₂Si(CH₂)₃—O—CH₂—CH(O)CH₂, [(C₁₈H₃₇O—(CH₂—CH₂O)₅](MeO)₂Si(CH₂)₃—O—CH₂—CH(O)CH₂, [(C₁₈H₃₇O—(CH₂—CH₂O)₆](MeO)₂Si(CH₂)₃—O—CH₂—CH(O)CH₂,
[(C₉H₁₉O—(CH₂—CH₂O)₂]₂(MeO)Si(CH₂)₃—O—CH₂—CH(O)CH₂, [(C₉H₁₉O—(CH₂—CH₂O)₃]₂(MeO)Si(CH₂)₃—O—CH₂—CH(O)CH₂, [(C₉H₁₉O—(CH₂—CH₂O)₄]₂(MeO)Si(CH₂)₃—O—CH₂—CH(O)CH₂, [(C₉H₁₉O—(CH₂—CH₂O)₅]₂(MeO)Si(CH₂)₃—O—CH₂—CH(O)CH₂, [(C₉H₁₉O—(CH₂—CH₂O)₆]₂(MeO)Si(CH₂)₃—O—CH₂—CH(O)CH₂,
[(C₁₂H₂₅O—(CH₂—CH₂O)₂]₂(MeO)Si(CH₂)₃—O—CH₂—CH(O)CH₂, [(C₁₂H₂₅O—(CH₂—CH₂O)₃]₂(MeO)Si(CH₂)₃—O—CH₂—CH(O)CH₂, [(C₁₂H₂₅O—(CH₂—CH₂O)₄]₂(MeO)Si(CH₂)₃—O—CH₂—CH(O)CH₂, [(C₁₂H₂₅O—(CH₂—CH₂O)₅]₂(MeO)Si(CH₂)₃—O—CH₂—CH(O)CH₂, [(C₁₂H₂₅O—(CH₂—CH₂O)₆]₂(MeO)Si(CH₂)₃—O—CH₂—CH(O)CH₂,
[(C₁₃H₂₇O—(CH₂—CH₂O)₂]₂(MeO)Si(CH₂)₃—O—CH₂—CH(O)CH₂, [(C₁₃H₂₇O—(CH₂—CH₂O)₃]₂(MeO)Si(CH₂)₃—O—CH₂—CH(O)CH₂, [(C₁₃H₂₇O—(CH₂—CH₂O)₄]₂(MeO)Si(CH₂)₃—O—CH₂—CH(O)CH₂, [(C₁₃H₂₇O—(CH₂—CH₂O)₅]₂(MeO)Si(CH₂)₃—O—CH₂—CH(O)CH₂, [(C₁₃H₂₇O—(CH₂—CH₂O)₆]₂(MeO)Si(CH₂)₃—O—CH₂—CH(O)CH₂,
[(C₁₄H₂₉O—(CH₂—CH₂O)₂]₂(MeO)Si(CH₂)₃—O—CH₂—CH(O)CH₂, [(C₁₄H₂₉O—(CH₂—CH₂O)₃]₂(MeO)Si(CH₂)₃—O—CH₂—CH(O)CH₂, [(C₁₄H₂₉O—(CH₂—CH₂O)₄]₂(MeO)Si(CH₂)₃—O—CH₂—CH(O)CH₂, [(C₁₄H₂₉O—(CH₂—CH₂O)₅]₂(MeO)Si(CH₂)₃—O—CH₂—CH(O)CH₂, [(C₁₄H₂₉O—(CH₂—CH₂O)₆]₂(MeO)Si(CH₂)₃—O—CH₂—CH(O)CH₂,
[(C₁₆H₃₃O—(CH₂—CH₂O)₂]₂(MeO)Si(CH₂)₃—O—CH₂—CH(O)CH₂, [(C₁₆H₃₃O—(CH₂—CH₂O)₃]₂(MeO)Si(CH₂)₃—O—CH₂—CH(O)CH₂, [(C₁₆H₃₃O—(CH₂—CH₂O)₄]₂(MeO)Si(CH₂)₃—O—CH₂—CH(O)CH₂, [(C₁₆H₃₃O—(CH₂—CH₂O)₅]₂(MeO)Si(CH₂)₃—O—CH₂—CH(O)CH₂, [(C₁₆H₃₃O—(CH₂—CH₂O)₆]₂(MeO)Si(CH₂)₃—O—CH₂—CH(O)CH₂,
[(C₁₈H₃₇O—(CH₂—CH₂O)₂]₂(MeO)Si(CH₂)₃—O—CH₂—CH(O)CH₂, [(C₁₈H₃₇O—(CH₂—CH₂O)₃]₂(MeO)Si(CH₂)₃—O—CH₂—CH(O)CH₂, [(C₁₈H₃₇O—(CH₂—CH₂O)₄]₂(MeO)Si(CH₂)₃—O—CH₂—CH(O)CH₂, [(C₁₈H₃₇O—(CH₂—CH₂O)₅]₂(MeO)Si(CH₂)₃—O—CH₂—CH(O)CH₂, [(C₁₈H₃₇O—(CH₂—CH₂O)₆]₂(MeO)Si(CH₂)₃—O—CH₂—CH(O)CH₂,
[(C₇H₁₅O—(CH₂—CH₂O)₂](EtO)₂Si(CH₂)₃—O—CH₂—CH(O)CH₂, [(C₇H₁₅O—(CH₂—CH₂O)₃](EtO)₂Si(CH₂)₃—O—CH₂—CH(O)CH₂, [(C₇H₁₅O—(CH₂—CH₂O)₄](EtO)₂Si(CH₂)₃—O—CH₂—CH(O)CH₂, [(C₇H₁₅O—(CH₂—CH₂O)₅](EtO)₂Si(CH₂)₃—O—CH₂—CH(O)CH₂, [(C₇H₁₅O—(CH₂—CH₂O)₆](EtO)₂Si(CH₂)₃—O—CH₂—CH(O)CH₂,
[(C₈H₁₇O—(CH₂—CH₂O)₂](EtO)₂Si(CH₂)₃—O—CH₂—CH(O)CH₂, [(C₈H₁₇O—(CH₂—CH₂O)₃](EtO)₂Si(CH₂)₃—O—CH₂—CH(O)CH₂, [(C₈H₁₇O—(CH₂—CH₂O)₄](EtO)₂Si(CH₂)₃—O—CH₂—CH(O)CH₂, [(C₈H₁₇O—(CH₂—CH₂O)₅](EtO)₂Si(CH₂)₃—O—CH₂—CH(O)CH₂, [(C₈H₁₇O—(CH₂—CH₂O)₆](EtO)₂Si(CH₂)₃—O—CH₂—CH(O)CH₂,
[(C₉H₁₉O—(CH₂—CH₂O)₂](EtO)₂Si(CH₂)₃—O—CH₂—CH(O)CH₂, [(C₉H₁₉O—(CH₂—CH₂O)₃](EtO)₂Si(CH₂)₃—O—CH₂—CH(O)CH₂, [(C₉H₁₉O—(CH₂—CH₂O)₄](EtO)₂Si(CH₂)₃—O—CH₂—CH(O)CH₂, [(C₉H₁₉O—(CH₂—CH₂O)₅](EtO)₂Si(CH₂)₃—O—CH₂—CH(O)CH₂, [(C₉H₁₉O—(CH₂—CH₂O)₆](EtO)₂Si(CH₂)₃—O—CH₂—CH(O)CH₂,
[(C₁₀H₂₁O—(CH₂—CH₂O)₂](EtO)₂Si(CH₂)₃—O—CH₂—CH(O)CH₂, [(C₁₀H₂₁O—(CH₂—CH₂O)₃](EtO)₂Si(CH₂)₃—O—CH₂—CH(O)CH₂, [(C₁₀H₂₁O—(CH₂—CH₂O)₄](EtO)₂Si(CH₂)₃—O—CH₂—CH(O)CH₂, [(C₁₀H₂₁O—(CH₂—CH₂O)₅](EtO)₂Si(CH₂)₃—O—CH₂—CH(O)CH₂, [(C₁₀H₂₁O—(CH₂—CH₂O)₆](EtO)₂Si(CH₂)₃—O—CH₂—CH(O)CH₂,
[(C₁₁H₂₃O—(CH₂—CH₂O)₂](EtO)₂Si(CH₂)₃—O—CH₂—CH(O)CH₂, [(C₁₁H₂₃O—(CH₂—CH₂O)₃](EtO)₂Si(CH₂)₃—O—CH₂—CH(O)CH₂, [(C₁₁H₂₃O—(CH₂—CH₂O)₄](EtO)₂Si(CH₂)₃—O—CH₂—CH(O)CH₂, [(C₁₁H₂₃O—(CH₂—CH₂O)₅](EtO)₂Si(CH₂)₃—O—CH₂—CH(O)CH₂, [(C₁₁H₂₃O—(CH₂—CH₂O)₆](EtO)₂Si(CH₂)₃—O—CH₂—CH(O)CH₂,
[(C₁₂H₂₅O—(CH₂—CH₂O)₂](EtO)₂Si(CH₂)₃—O—CH₂—CH(O)CH₂, [(C₁₂H₂₅O—(CH₂—CH₂O)₃](EtO)₂Si(CH₂)₃—O—CH₂—CH(O)CH₂, [(C₁₂H₂₅O—(CH₂—CH₂O)₄](EtO)₂Si(CH₂)₃—O—CH₂—CH(O)CH₂, [(C₁₂H₂₅O—(CH₂—CH₂O)₅](EtO)₂Si(CH₂)₃—O—CH₂—CH(O)CH₂, [(C₁₂H₂₅O—(CH₂—CH₂O)₆](EtO)₂Si(CH₂)₃—O—CH₂—CH(O)CH₂,
[(C₁₃H₂₇O—(CH₂—CH₂O)₂](EtO)₂Si(CH₂)₃—O—CH₂—CH(O)CH₂, [(C₁₃H₂₇O—(CH₂—CH₂O)₃](EtO)₂Si(CH₂)₃—O—CH₂—CH(O)CH₂, [(C₁₃H₂₇O—(CH₂—CH₂O)₄](EtO)₂Si(CH₂)₃—O—CH₂—CH(O)CH₂, [(C₁₃H₂₇O—(CH₂—CH₂O)₅](EtO)₂Si(CH₂)₃—O—CH₂—CH(O)CH₂, [(C₁₃H₂₇O—(CH₂—CH₂O)₆](EtO)₂Si(CH₂)₃—O—CH₂—CH(O)CH₂,
[(C₁₄H₂₉O—(CH₂—CH₂O)₂](EtO)₂Si(CH₂)₃—O—CH₂—CH(O)CH₂, [(C₁₄H₂₉O—(CH₂—CH₂O)₃](EtO)₂Si(CH₂)₃—O—CH₂—CH(O)CH₂, [(C₁₄H₂₉O—(CH₂—CH₂O)₄](EtO)₂Si(CH₂)₃—O—CH₂—CH(O)CH₂, [(C₁₄H₂₉O—(CH₂—CH₂O)₅](EtO)₂Si(CH₂)₃—O—CH₂—CH(O)CH₂, [(C₁₄H₂₉O—(CH₂—CH₂O)₆](EtO)₂Si(CH₂)₃—O—CH₂—CH(O)CH₂,
[(C₁₆H₃₃O—(CH₂—CH₂O)₂](EtO)₂Si(CH₂)₃—O—CH₂—CH(O)CH₂, [(C₁₆H₃₃O—(CH₂—CH₂O)₃](EtO)₂Si(CH₂)₃—O—CH₂—CH(O)CH₂, [(C₁₆H₃₃O—(CH₂—CH₂O)₄](EtO)₂Si(CH₂)₃—O—CH₂—CH(O)CH₂, [(C₁₆H₃₃O—(CH₂—CH₂O)₅](EtO)₂Si(CH₂)₃—O—CH₂—CH(O)CH₂, [(C₁₆H₃₃O—(CH₂—CH₂O)₆](EtO)₂Si(CH₂)₃—O—CH₂—CH(O)CH₂,
[(C₁₇H₃₅O—(CH₂—CH₂O)₂](EtO)₂Si(CH₂)₃—O—CH₂—CH(O)CH₂, [(C₁₇H₃₅O—(CH₂—CH₂O)₃](EtO)₂Si(CH₂)₃—O—CH₂—CH(O)CH₂, [(C₁₇H₃₅O—(CH₂—CH₂O)₄](EtO)₂Si(CH₂)₃—O—CH₂—CH(O)CH₂, [(C₁₇H₃₅O—(CH₂—CH₂O)₅](EtO)₂Si(CH₂)₃—O—CH₂—CH(O)CH₂, [(C₁₇H₃₅O—(CH₂—CH₂O)₆](EtO)₂Si(CH₂)₃—O—CH₂—CH(O)CH₂,
[(C₁₈H₃₇O—(CH₂—CH₂O)₂](EtO)₂Si(CH₂)₃—O—CH₂—CH(O)CH₂, [(C₁₈H₃₇O—(CH₂—CH₂O)₃](EtO)₂Si(CH₂)₃—O—CH₂—CH(O)CH₂, [(C₁₈H₃₇O—(CH₂—CH₂O)₄](EtO)₂Si(CH₂)₃—O—CH₂—CH(O)CH₂, [(C₁₈H₃₇O—(CH₂—CH₂O)₅](EtO)₂Si(CH₂)₃—O—CH₂—CH(O)CH₂, [(C₁₈H₃₇O—(CH₂—CH₂O)₆](EtO)₂Si(CH₂)₃—O—CH₂—CH(O)CH₂,
[(C₇H₁₅O—(CH₂—CH₂O)₂]₂(EtO)Si(CH₂)₃—O—CH₂—CH(O)CH₂, [(C₇H₁₅O—(CH₂—CH₂O)₃]₂(EtO)Si(CH₂)₃—O—CH₂—CH(O)CH₂, [(C₇H₁₅O—(CH₂—CH₂O)₄]₂(EtO)Si(CH₂)₃—O—CH₂—CH(O)CH₂, [(C₇H₁₅O—(CH₂—CH₂O)₅]₂(EtO)Si(CH₂)₃—O—CH₂—CH(O)CH₂, [(C₇H₁₅O—(CH₂—CH₂O)₆]₂(EtO)Si(CH₂)₃—O—CH₂—CH(O)CH₂,
[(C₈H₁₇O—(CH₂—CH₂O)₂]₂(EtO)Si(CH₂)₃—O—CH₂—CH(O)CH₂, [(C₈H₁₇O—(CH₂—CH₂O)₃]₂(EtO)Si(CH₂)₃—O—CH₂—CH(O)CH₂, [(C₈H₁₇O—(CH₂—CH₂O)₄]₂(EtO)Si(CH₂)₃—O—CH₂—CH(O)CH₂, [(C₈H₁₇O—(CH₂—CH₂O)₅]₂(EtO)Si(CH₂)₃—O—CH₂—CH(O)CH₂, [(C₈H₁₇O—(CH₂—CH₂O)₆]₂(EtO)Si(CH₂)₃—O—CH₂—CH(O)CH₂,
[(C₉H₁₉O—(CH₂—CH₂O)₂]₂(EtO)Si(CH₂)₃—O—CH₂—CH(O)CH₂, [(C₉H₁₉O—(CH₂—CH₂O)₃]₂(EtO)Si(CH₂)₃—O—CH₂—CH(O)CH₂, [(C₉H₁₉O—(CH₂—CH₂O)₄]₂(EtO)Si(CH₂)₃—O—CH₂—CH(O)CH₂, [(C₉H₁₉O—(CH₂—CH₂O)₅]₂(EtO)Si(CH₂)₃—O—CH₂—CH(O)CH₂, [(C₉H₁₉O—(CH₂—CH₂O)₆]₂(EtO)Si(CH₂)₃—O—CH₂—CH(O)CH₂,
[(C₁₂H₂₅O—(CH₂—CH₂O)₂]₂(EtO)Si(CH₂)₃—O—CH₂—CH(O)CH₂, [(C₁₂H₂₅O—(CH₂—CH₂O)₃]₂(EtO)Si(CH₂)₃—O—CH₂—CH(O)CH₂, [(C₁₂H₂₅O—(CH₂—CH₂O)₄]₂(EtO)Si(CH₂)₃—O—CH₂—CH(O)CH₂, [(C₁₂H₂₅O—(CH₂—CH₂O)₅]₂(EtO)Si(CH₂)₃—O—CH₂—CH(O)CH₂, [(C₁₂H₂₅O—(CH₂—CH₂O)₆]₂(EtO)Si(CH₂)₃—O—CH₂—CH(O)CH₂,
[(C₁₃H₂₇O—(CH₂—CH₂O)₂]₂(EtO)Si(CH₂)₃—O—CH₂—CH(O)CH₂, [(C₁₃H₂₇O—(CH₂—CH₂O)₃]₂(EtO)Si(CH₂)₃—O—CH₂—CH(O)CH₂, [(C₁₃H₂₇O—(CH₂—CH₂O)₄]₂(EtO)Si(CH₂)₃—O—CH₂—CH(O)CH₂, [(C₁₃H₂₇O—(CH₂—CH₂O)₅]₂(EtO)Si(CH₂)₃—O—CH₂—CH(O)CH₂, [(C₁₃H₂₇O—(CH₂—CH₂O)₆]₂(EtO)Si(CH₂)₃—O—CH₂—CH(O)CH₂,
[(C₁₄H₂₉O—(CH₂—CH₂O)₂]₂(EtO)Si(CH₂)₃—O—CH₂—CH(O)CH₂, [(C₁₄H₂₉O—(CH₂—CH₂O)₃]₂(EtO)Si(CH₂)₃—O—CH₂—CH(O)CH₂, [(C₁₄H₂₉O—(CH₂—CH₂O)₄]₂(EtO)Si(CH₂)₃—O—CH₂—CH(O)CH₂, [(C₁₄H₂₉O—(CH₂—CH₂O)₅]₂(EtO)Si(CH₂)₃—O—CH₂—CH(O)CH₂, [(C₁₄H₂₉O—(CH₂—CH₂O)₆]₂(EtO)Si(CH₂)₃—O—CH₂—CH(O)CH₂,
[(C₁₆H₃₃O—(CH₂—CH₂O)₂]₂(EtO)Si(CH₂)₃—O—CH₂—CH(O)CH₂, [(C₁₆H₃₃O—(CH₂—CH₂O)₃]₂(EtO)Si(CH₂)₃—O—CH₂—CH(O)CH₂, [(C₁₆H₃₃O—(CH₂—CH₂O)₄]₂(EtO)Si(CH₂)₃—O—CH₂—CH(O)CH₂, [(C₁₆H₃₃O—(CH₂—CH₂O)₅]₂(EtO)Si(CH₂)₃—O—CH₂—CH(O)CH₂, [(C₁₆H₃₃O—(CH₂—CH₂O)₆]₂(EtO)Si(CH₂)₃—O—CH₂—CH(O)CH₂,
[(C₁₇H₃₅O—(CH₂—CH₂O)₂]₂(EtO)Si(CH₂)₃—O—CH₂—CH(O)CH₂, [(C₁₇H₃₅O—(CH₂—CH₂O)₃]₂(EtO)Si(CH₂)₃—O—CH₂—CH(O)CH₂, [(C₁₇H₃₅O—(CH₂—CH₂O)₄]₂(EtO)Si(CH₂)₃—O—CH₂—CH(O)CH₂, [(C₁₇H₃₅O—(CH₂—CH₂O)₅]₂(EtO)Si(CH₂)₃—O—CH₂—CH(O)CH₂, [(C₁₇H₃₅O—(CH₂—CH₂O)₆]₂(EtO)Si(CH₂)₃—O—CH₂—CH(O)CH₂,
[(C₁₈H₃₇O—(CH₂—CH₂O)₂]₂(EtO)Si(CH₂)₃—O—CH₂—CH(O)CH₂, [(C₁₈H₃₇O—(CH₂—CH₂O)₃]₂(EtO)Si(CH₂)₃—O—CH₂—CH(O)CH₂, [(C₁₈H₃₇O—(CH₂—CH₂O)₄]₂(EtO)Si(CH₂)₃—O—CH₂—CH(O)CH₂, [(C₁₈H₃₇O—(CH₂—CH₂O)₅]₂(EtO)Si(CH₂)₃—O—CH₂—CH(O)CH₂, [(C₁₈H₃₇O—(CH₂—CH₂O)₆]₂(EtO)Si(CH₂)₃—O—CH₂—CH(O)CH₂,
[(C₇H₁₅O—(CH₂—CH₂O)₂]₃Si(CH₂)₃—O—CH₂—CH(O)CH₂, [(C₇H₁₅O—(CH₂—CH₂O)₃]₃Si(CH₂)₃—O—CH₂—CH(O)CH₂, [(C₇H₁₅O—(CH₂—CH₂O)₄]₃Si(CH₂)₃—O—CH₂—CH(O)CH₂, [(C₇H₁₅O—(CH₂—CH₂O)₅]₃Si(CH₂)₃—O—CH₂—CH(O)CH₂, [(C₇H₁₅O—(CH₂—CH₂O)₆]₃Si(CH₂)₃—O—CH₂—CH(O)CH₂,
[(C₈H₁₇O—(CH₂—CH₂O)₂]₃Si(CH₂)₃—O—CH₂—CH(O)CH₂, [(C₈H₁₇O—(CH₂—CH₂O)₃]₃Si(CH₂)₃—O—CH₂—CH(O)CH₂, [(C₈H₁₇O—(CH₂—CH₂O)₄]₃Si(CH₂)₃—O—CH₂—CH(O)CH₂, [(C₈H₁₇O—(CH₂—CH₂O)₅]₃Si(CH₂)₃—O—CH₂—CH(O)CH₂, [(C₈H₁₇O—(CH₂—CH₂O)₆]₃Si(CH₂)₃—O—CH₂—CH(O)CH₂,
[(C₉H₁₉O—(CH₂—CH₂O)₂]₃Si(CH₂)₃—O—CH₂—CH(O)CH₂, [(C₉H₁₉O—(CH₂—CH₂O)₃]₃Si(CH₂)₃—O—CH₂—CH(O)CH₂, [(C₉H₁₉O—(CH₂—CH₂O)₄]₃Si(CH₂)₃—O—CH₂—CH(O)CH₂, [(C₉H₁₉O—(CH₂—CH₂O)₅]₃Si(CH₂)₃—O—CH₂—CH(O)CH₂, [(C₉H₁₉O—(CH₂—CH₂O)₆]₃Si(CH₂)₃—O—CH₂—CH(O)CH₂,
[(C₁₀H₂₁O—(CH₂—CH₂O)₂]₃Si(CH₂)₃—O—CH₂—CH(O)CH₂, [(C₁₀H₂₁O—(CH₂—CH₂O)₃]₃Si(CH₂)₃—O—CH₂—CH(O)CH₂, [(C₁₀H₂₁O—(CH₂—CH₂O)₄]₃Si(CH₂)₃—O—CH₂—CH(O)CH₂, [(C₁₀H₂₁O—(CH₂—CH₂O)₅]₃Si(CH₂)₃—O—CH₂—CH(O)CH₂, [(C₁₀H₂₁O—(CH₂—CH₂O)₆]₃Si(CH₂)₃—O—CH₂—CH(O)CH₂,
[(C₁₂H₂₅O—(CH₂—CH₂O)₂]₃Si(CH₂)₃—O—CH₂—CH(O)CH₂, [(C₁₂H₂₅O—(CH₂—CH₂O)₃]₃Si(CH₂)₃—O—CH(O)CH₂, [(C₁₂H₂₅O—(CH₂—CH₂O)₄]₃Si(CH₂)₃—O—CH₂—CH(O)CH₂, [(C₁₂H₂₅O—(CH₂—CH₂O)₅]₃Si(CH₂)₃—O—CH₂—CH(O)CH₂, [(C₁₂H₂₅O—(CH₂—CH₂O)₆]₃Si(CH₂)₃—O—CH₂—CH(O)CH₂,
[(C₁₃H₂₇O—(CH₂—CH₂O)₂]₃Si(CH₂)₃—O—CH₂—CH(O)CH₂, [(C₁₃H₂₇O—(CH₂—CH₂O)₃]₃Si(CH₂)₃—O—CH₂—CH(O)CH₂, [(C₁₃H₂₇O—(CH₂—CH₂O)₄]₃Si(CH₂)₃—O—CH₂—CH(O)CH₂, [(C₁₃H₂₇O—(CH₂—CH₂O)₅]₃Si(CH₂)₃—O—CH₂—CH(O)CH₂, [(C₁₃H₂₇O—(CH₂—CH₂O)₆]₃Si(CH₂)₃—O—CH₂—CH(O)CH₂,
[(C₁₄H₂₉O—(CH₂—CH₂O)₂]₃Si(CH₂)₃—O—CH₂—CH(O)CH₂, [(C₁₄H₂₉O—(CH₂—CH₂O)₃]₃Si(CH₂)₃—O—CH₂—CH(O)CH₂, [(C₁₄H₂₉O—(CH₂—CH₂O)₄]₃Si(CH₂)₃—O—CH₂—CH(O)CH₂, [(C₁₄H₂₉O—(CH₂—CH₂O)₅]₃Si(CH₂)₃—O—CH₂—CH(O)CH₂, [(C₁₄H₂₉O—(CH₂—CH₂O)₆]₃Si(CH₂)₃—O—CH₂—CH(O)CH₂,
[(C₁₅H₃₁O—(CH₂—CH₂O)₂]₃Si(CH₂)₃—O—CH₂—CH(O)CH₂, [(C₁₅H₃₁O—(CH₂—CH₂O)₃]₃Si(CH₂)₃—O—CH₂—CH(O)CH₂, [(C₁₅H₃₁O—(CH₂—CH₂O)₄]₃Si(CH₂)₃—O—CH₂—CH(O)CH₂, [(C₁₅H₃₁O—(CH₂—CH₂O)₅]₃Si(CH₂)₃—O—CH₂—CH(O)CH₂, [(C₁₅H₃₁O—(CH₂—CH₂O)₆]₃Si(CH₂)₃—O—CH₂—CH(O)CH₂,
[(C₁₆H₃₃O—(CH₂—CH₂O)₂]₃Si(CH₂)₃—O—CH₂—CH(O)CH₂, [(C₁₆H₃₃O—(CH₂—CH₂O)₃]₃Si(CH₂)₃—O—CH₂—CH(O)CH₂, [(C₁₆H₃₃O—(CH₂—CH₂O)₄]₃Si(CH₂)₃—O—CH₂—CH(O)CH₂, [(C₁₆H₃₃O—(CH₂—CH₂O)₅]₃Si(CH₂)₃—O—CH₂—CH(O)CH₂, [(C₁₆H₃₃O—(CH₂—CH₂O)₆]₃Si(CH₂)₃—O—CH₂—CH(O)CH₂,
[(C₁₈H₃₇O—(CH₂—CH₂O)₂]₃Si(CH₂)₃—O—CH₂—CH(O)CH₂, [(C₁₈H₃₇O—(CH₂—CH₂O)₃]₃Si(CH₂)₃—O—CH₂—CH(O)CH₂, [(C₁₈H₃₇O—(CH₂—CH₂O)₄]₃Si(CH₂)₃—O—CH₂—CH(O)CH₂, [(C₁₈H₃₇O—(CH₂—CH₂O)₅]₃Si(CH₂)₃—O—CH₂—CH(O)CH₂, [(C₁₈H₃₇O—(CH₂—CH₂O)₆]₃Si(CH₂)₃—O—CH₂—CH(O)CH₂,
(C₂H₅O)₃Si(CH₂)₃—O—CH₂—CH(O)CH₂, (CH₃O)₃Si(CH₂)₃—O—CH₂—CH(O)CH₂, (C₃H₇O)₃Si(CH₂)₃—O—CH₂—CH(O)CH₂, (CH₃)(C₂H₅O)₂Si(CH₂)₃—O—CH₂—CH(O)CH₂, (CH₃)₂(C₂H₅O)Si(CH₂)₃—O—CH₂—CH(O)CH₂, (CH₃)(CH₃O)₂Si(CH₂)₃—O—CH₂—CH(O)CH₂, (CH₃)₂(CH₃O)Si(CH₂)₃—O—CH₂—CH(O)CH₂,
(C₂H₅O)₃Si—CH₂—O—(CH₂)₃—O—CH(O)CH₂, (CH₃O)₃Si—CH₂—O—(CH₂)₃—O—CH(O)CH₂, (C₃H₇O)₃Si—CH₂—O—(CH₂)₃—O—CH(O)CH₂, (CH₃)(C₂H₅O)₂Si—CH₂—O—(CH₂)₃—O—CH(O)CH₂, (CH₃)₂(C₂H₅O)Si—CH₂—O—(CH₂)₃—O—CH(O)CH₂, (CH₃)(CH₃O)₂Si—CH₂—O—(CH₂)₃—O—CH(O)CH₂, (CH₃)₂(CH₃O)Si—CH₂—O—(CH₂)₃—O—CH(O)CH₂,
(C₂H₅O)₃Si—(CH₂)₂—O—(CH₂)₂—CH(O)CH₂, (CH₃O)₃Si—(CH₂)₂—O—(CH₂)₂—CH(O)CH₂, (C₃H₇O)₃Si—(CH₂)₂—O—(CH₂)₂—CH(O)CH₂, (CH₃)(C₂H₅O)₂Si—(CH₂)₂—O—(CH₂)₂—CH(O)CH₂, (CH₃)₂(C₂H₅O)Si—(CH₂)₂—O—(CH₂)₂—CH(O)CH₂, (CH₃)(CH₃O)₂Si—(CH₂)₂—O—(CH₂)₂—CH(O)CH₂, (CH₃)₂(CH₃O)Si—(CH₂)₂—O—(CH₂)₂—CH(O)CH₂,
(C₂H₅O)₃Si—CH₂—O—CH₂—CH(O)CH₂, (CH₃O)₃Si—CH₂—O—CH₂—CH(O)CH₂, (C₃H₇O)₃Si—CH₂—O—CH₂—CH(O)CH₂, (CH₃)(C₂H₅O)₂Si—CH₂—O—CH₂—CH(O)CH₂, (CH₃)₂(C₂H₅O)Si—CH₂—O—CH₂—CH(O)CH₂, (CH₃)(CH₃O)₂Si—CH₂—O—CH₂—CH(O)CH₂ or (CH₃)₂(CH₃O)Si—CH₂—O—CH₂—CH(O)CH₂,
where the alkyl moieties (Alk) can be unbranched or branched.

The rubber mixtures according to the invention can use ethoxysilanes of the general formula I or else mixtures of ethoxysilanes of the general formula I.

The rubber mixtures according to the invention can use hydrolysates, oligomeric or polymeric siloxanes and condensates of the compounds of the general formula I.

The form in which the ethoxysilanes of the formula I are added to the mixing process can either be pure form or else a form absorbed onto an inert organic or inorganic carrier, or else a form pre-reacted with an organic or inorganic carrier. Preferred carrier materials can be precipitated or fumed silicas, waxes, thermoplastics, natural or synthetic silicates, natural or synthetic oxides, for example aluminium oxide, or carbon blacks. Another form in which the ethoxysilanes of the formula I can be added to the mixing process is a form pre-reacted with the filler to be used.

Preferred waxes can be waxes with melting points, melting ranges or softening ranges from 50° to 200° C., preferably from 70° to 180° C., particularly preferably from 90° to 150° C., very particularly preferably from 100° to 120° C.

The waxes used can be olefinic waxes.

The waxes used can comprise saturated and unsaturated hydrocarbon chains.

The waxes used can comprise polymers or oligomers, preferably emulsion SBR or/and solution SBR.

The waxes used can comprise long-chain alkanes or/and long-chain carboxylic acids.

The waxes used can comprise ethylene-vinyl acetate and/or polyvinyl alcohols.

The form in which the ethoxysilanes of the formula I are added to the mixing process can be a form physically mixed with an organic substance or with an organic substance mixture.

The organic substance or the organic substance mixture can comprise polymers or oligomers.

Polymers or oligomers can be heteroatom-containing polymers or oligomers, for example ethylene-vinyl alcohol or/and polyvinyl alcohols.

Polymers or oligomers can be saturated or unsaturated elastomers, preferably emulsion SBR or/and solution SBR.

The melting point, melting range or softening range of the mixture of ethoxysilanes of formula I with organic substance or with an organic substance mixture can be from 50 to 200° C., preferably from 70 to 180° C., particularly preferably from 70 to 150° C., very particularly preferably from 70 to 130° C., exceptionally preferably from 90 to 110° C.

The following can be used as silicatic or oxidic fillers for the rubber mixtures according to the invention:
Amorphous silicas, produced by way of example via precipitation of solutions of silicates (precipitated silicas) or flame hydrolysis of silicon halides (fumed silicas). The specific surface areas of the amorphous silicas can be from to 1000 m²/g, preferably from 20 to 400 m²/g (BET surface area) and their primary particle sizes can be from 10 to 400 nm. The silicas can, if appropriate, also take the form of mixed oxides with other metal oxides, such as Al oxides, Mg oxides, Ca oxides, Ba oxides, Zn oxides and titanium oxides.
Synthetic silicates, such as aluminium silicate or alkaline earth metal silicates, such as magnesium silicate or calcium silicate. The BET surface areas of the synthetic silicates can be from 20 to 400 m²/g and their primary particle diameters can be from 10 to 400 nm.
Synthetic or natural aluminium oxides and synthetic or natural aluminium hydroxides.
Natural silicates, such as kaolin and other naturally occurring silicas.
Glass fiber and glass fiber products (mats, strands) or glass microbeads.

It may be preferable to use amorphous silicas prepared via precipitation of solutions of silicates (precipitated silicas) with BET surface areas of from 20 to 400 m²/g. The amounts that can be used of the amorphous silicas are from 5 to 150 parts by weight, based in each case on 100 parts of rubber (phr).

An example of a carbon black that can be used is lamp black, furnace black, gas black or thermal black. The BET surface area of the carbon blacks can be from 20 to 200 m²/g, preferably from 30 to 100 m²/g. The carbon blacks can optionally also comprise heteroatoms, for example Si. The amounts used of the carbon blacks can be from 5 to 150 parts by weight, based in each case on 100 parts of rubber (phr).

The fillers mentioned can be used alone or in a mixture.

In one particularly preferred embodiment, the rubber mixtures can comprise from 10 to 150 parts by weight of silicatic or oxidic fillers, optionally together with 0 to 100 parts by weight of carbon black, and also from 1 to 20 parts by weight of ethoxysilanes of the formula I, based in each case on 100 parts by weight of rubber.

In another particularly preferred embodiment, the rubber mixtures can comprise from 10 to 150 parts by weight of carbon black, optionally together with from 0 to 100 parts by weight of oxidic filler, and also from 1 to 20 parts by weight of ethoxysilanes of the formula I, based in each case on 100 parts by weight of rubber.

The polyacrylate rubber in the rubber mixtures according to the invention can by way of example be ACM polyacrylate rubber or ethylene-acrylate rubber (AEM). ACM has high resistance to oxygen, ozone and high temperatures and good resistance to swelling in mineral oils, but high water absorption and poor hydrolysis resistance. AEM is known by way of example with trade name VAMAC from DUPONT. The properties of AEM are like those of ACM except that it has better strength and heat resistance, but poorer resistance to mineral oil.

The rubber mixtures according to the invention can also comprise natural rubber or synthetic rubbers. Preferred synthetic rubbers are described by way of example in W. Hofmann, Kautschuktechnologie [Rubber technology], Genter Verlag, Stuttgart 1980. They comprise inter alia
polybutadiene (BR);
polyisoprene (IR);
styrene-butadiene copolymers (SBR), such as emulsion SBR (E-SBR) or solution SBR (S-SBR). The styrene-butadiene copolymers can have styrene content of from 1 to 60% by weight, preferably from 2 to 50% by weight, particularly preferably from 10 to 40% by weight, very particularly preferably from to 35% by weight;
chloroprene (CR);
isobutylene-isoprene copolymers (IIR);
butadiene-acrylonitrile copolymers whose acrylonitrile contents are from 5 to 60% by weight, preferably from 10 to 50% by weight (NBR), particularly preferably from 10 to 45% by weight (NBR), very particularly preferably from 19 to 45% by weight (NBR);
partially hydrogenated or fully hydrogenated NBR rubber (HNBR);
ethylene-propylene-diene copolymers (EPDM);
abovementioned rubbers which also have functional groups, e.g. carboxy groups, silanol groups or epoxy groups, e.g. epoxidized NR, carboxy-functionalized NBR or silanol- (—SiOH) or silyl-alkoxy-functionalized (—Si—OR) SBR;
   or a mixture of these rubbers.

The rubber mixtures according to the invention can comprise other rubber auxiliaries, such as reaction accelerators, antioxidants, heat stabilizers, light stabilizers, anti-ozonants, processing aids, plasticizers, tackifiers, blowing agents, dyes, pigments, waxes, extenders, organic acids, retarders, metal oxides, and also activators, such as triethanolamine or hexanetriol.

Other rubber auxiliaries can be: polyethylene glycol or/and polypropylene glycol or/and polybutylene glycol with molar masses from 50 to 50 000 g/mol, preferably from 50 to 20 000 g/mol, particularly preferably from 200 to 10 000 g/mol, very particularly preferably from 400 to 6000 g/mol, exceptionally preferably from 500 to 3000 g/mol,

hydrocarbon-terminated polyethylene glycol Alk^{I}-O—(CH₂—CH₂—O)_{yI}—H or Alk^{I}-(CH₂—CH₂—O)_{yI}-Alk^{I},
hydrocarbon-terminated polypropylene glycol Alk^{I}-O—(CH₂—CH(CH₃)—O)_{yI}—H or Alk^{I}-O—(CH₂—CH(CH₃)—O)_{yI}-Alk^{I},
hydrocarbon-terminated polybutylene glycol Alk^{I}-O—(CH₂—CH₂—CH₂—CH₂—O)_{yI}—H, Alk^{I}-O—(CH₂—CH(CH₃)—CH₂—O)_{yT}—H, Alk^{I}-O—(CH₂—CH₂—CH₂—CH₂—O)_{yI}-Alk^{I} or Alk^{I}-O—(CH₂—CH(CH₃)—CH₂—O)_{yI}-Alk^{I},
where the average of y^{I} is from 2 to 25, preferably from 2 to 15, particularly preferably from 3 to 8 and from 10 to 14, very particularly preferably from 3 to 6 and from 10 to 13, and Alk^{I} is a branched or unbranched, unsubstituted or substituted, saturated or unsaturated hydrocarbon having from 1 to 35, preferably from 4 to 25, particularly preferably from 6 to 20, very particularly preferably from 10 to 20, exceptionally preferably from 11 to 14, carbon atoms,
neopentyl glycol HO—CH₂—C(Me)₂-CH₂—OH, pentaerythritol C(CH₂—OH)₄ or trimethylolpropane CH₃—CH₂—C(CH₂—OH)₃ etherified with polyethylene glycol, etherified with polypropylene glycol, etherified with polybutylene glycol, or etherified with a mixture thereof, where the number of repeat units of ethylene glycol, propylene glycol or/and butylene glycol in the etherified polyalcohols can be from 2 to 100, preferably from 2 to 50, particularly preferably from 3 to 30, very particularly preferably from 3 to 15.

To calculate the average of y^{I}, the analytically determinable amount of polyalkylene glycol units can be divided by the analytically determinable amount of -Alk^{I} [(amount of polyalkylene glycol units)/(amount of -Alk^{I})]. By way of example, ¹H and ¹³C nuclear resonance spectroscopy can be used to determine the amounts.

The rubber mixture according to the invention can comprise further silanes.

Further silanes that can be added to the rubber mixtures according to the invention are mercapto-organylsilanes containing ethoxysilyl groups, or/and thiocyanato-organylsilanes containing ethoxy-silyl groups,

or/and blocked mercapto-organylsilanes containing ethoxysilyl groups,
or/and polysulfidic alkoxysilanes containing ethoxysilyl groups.

Further silanes that can be added to the rubber mixtures according to the invention are mercapto-organylsilanes containing triethoxysilyl groups,

or/and thiocyanato-organylsilanes containing tri-ethoxysilyl groups,
or/and blocked mercapto-organylsilanes containing triethoxysilyl groups,
or/and polysulfidic alkoxysilanes containing triethoxy-silyl groups.

Further silanes that can be added to the rubber mixtures according to the invention are mercapto-organyl(alkoxysilanes) having C₈H₁₇—O—, C₁₀H₂₁—O—, C₁₂H₂₅—O—, C₁₄H₂₉—O—, C₁₆H₃₃—O—, or C₁₈H₃₇—O— groups on silicon.

Further silanes that can be added to the rubber mixtures according to the invention are blocked mercapto-organyl(alkoxysilanes) having C₈H₁₇—O—, C₁₀H₂₁—O—, C₁₂H₂₅—O—, C₁₄H₂₉—O—, C₁₆H₃₃—O—, or C₁₈H₃₇—O— groups on silicon.

Further silanes that can be added to the rubber mixtures according to the invention are blocked mercapto-organyl(alkoxysilanes) having difunctional alcohols (diols) on silicon (e.g. NXT LowV or NXT Ultra-LowV from General Electric).

Further silanes that can be added to the rubber mixtures according to the invention are polysulfidic alkoxysilanes of the formulae

EtO—Si(Me)₂-CH₂—CH₂—CH₂—S₂—CH₂—CH₂—CH₂—Si(Me)₂(OEt), EtO—Si(Me)₂-CH₂—CH₂—CH₂—S₃—CH₂—CH₂—CH₂—Si(Me)₂(OEt), or EtO—Si(Me)₂-CH₂—CH₂—CH₂—S₄—CH₂—CH₂—CH₂—Si(Me)₂(OEt)

Further silanes that can be added to the rubber mixtures according to the invention are 3-mercaptopropyl(triethoxysilane) (for example Si 263 from Evonik Industries AG),

3-thiocyanatopropyl(triethoxysilane) (for example Si 264 from Evonik Industries AG),
bis(triethoxysilylpropyl)polysulfide (for example Si 69 from Evonik Industries AG),
bis(triethoxysilylpropyl)disulfide (for example Si 266 from Evonik Industries AG).

Further silanes that can be added to the rubber mixtures according to the invention are alkylpolyether-alcohol-containing mercapto-organylsilanes (such as Si 363 from Evonik Industries AG),

or/and alkylpolyether-alcohol-containing thiocyanato-organylsilanes,
or/and alkylpolyether-alcohol-containing, blocked mercapto-organylsilanes,
or/and alkylpolyether-alcohol-containing, polysulfidic silanes.

The alkylpolyether-alcohol-containing mercapto-organyl-silanes can be compounds of the general formula II

(X)₃Si—R—SH II,

where at least one X is an alkylpolyether group.

The alkylpolyether-alcohol-containing, blocked mercaptoorganylsilanes can be compounds of the general formula III

(X)₃Si—R^{I}—S—C(O)-Alk^{II} III

where at least one X is an alkylpolyether group and Alk^{II} is a branched or unbranched, saturated or unsaturated, substituted or unsubstituted, aliphatic, aromatic or mixed aliphatic/aromatic monovalent hydrocarbon group, preferably C₁-C₂₅—, particularly preferably C₂-C₂₂—, very particularly preferably C₇-C₁₇—, exceptionally preferably C₁₁-C₁₆—, hydrocarbon group.

The amounts used of the rubber auxiliaries can be known amounts, depending inter alia on the intended purpose. As a function of the processing aid used, conventional amounts can be amounts of from 0.001 to 50% by weight, preferably from 0.001 to 30% by weight, particularly preferably from 0.01 to 30% by weight, very particularly preferably from 0.1 to 30% by weight, based on rubber (phr).

The rubber mixtures according to the invention can be sulphur-vulcanizable rubber mixtures.

The rubber mixtures according to the invention can be peroxidically crosslinkable rubber mixtures.

Crosslinking agents that can be used are sulphur or sulphur-donor substances. The amounts used of sulphur can be from 0.1 to 10% by weight, preferably from 0.1 to 5% by weight, based on rubber.

The rubber mixtures according to the invention can comprise further vulcanization accelerators.

Amounts that can be used of the vulcanization accelerators are from 0.1 to 10% by weight, preferably from 0.1 to 5% by weight, based on the rubber used.

The rubber mixtures according to the invention can comprise

(D) a thiuram sulfide accelerator and/or carbamate accelerator, and/or the corresponding zinc salts,
(E) optionally a nitrogen-containing coactivator,
(F) optionally further rubber auxiliaries, and
(G) optionally further accelerators.

The invention further provides a process for the production of the rubber mixtures according to the invention, which is characterized in that at least one polyacrylate rubber, at least one silicatic or oxidic filler or carbon black and at least one epoxysilane are mixed.

The epoxysilane can be an epoxysilane of the general formula I.

The process according to the invention can be carried out at temperatures >25° C.

The process according to the invention can be carried out in the temperature range from 80° C. to 200° C., preferably from 100° C. to 180° C., particularly preferably from 110° C. to 160° C.

The process can be carried out continuously or batchwise.

The addition of the epoxysilane of the general formula I, and also the addition of the fillers, can take place when the temperatures of the composition are from 100 to 200° C. However, it can also take place at lower temperatures of from 40 to 100° C., e.g. together with further rubber auxiliaries.

The blending of the rubbers with the filler and optionally with rubber auxiliaries and with the epoxysilane of the general formula I can take place in or on conventional mixing assemblies, such as rolls, internal mixers, and mixing extruders. These rubber mixtures can usually be produced in internal mixers, beginning with one or more successive thermomechanical mixing stages in which the rubbers, the filler, the epoxysilane of the general formula I and the rubber auxiliaries are incorporated by mixing at from 100 to 170° C. The sequence of addition and the juncture of addition of the individual components here can have a decisive effect on the resultant properties of the mixture. The crosslinking chemicals can usually be admixed in an internal mixer or on a roll at from 40 to 110° C. with the rubber mixture thus obtained, and processed to give what is known as a crude mixture for the subsequent steps of the process, for example shaping and vulcanization.

Vulcanization of the rubber mixtures according to the invention can take place at temperatures of from 80 to 200° C., preferably from 130 to 180° C., if appropriate under a pressure of from 10 to 200 bar.

The rubber mixtures according to the invention can be used for the production of mouldings, for example for the production of air springs, pneumatic and other tyres, tyre treads, cable sheathing, hoses, drive belts, conveyor belts, roll coverings, shoe soles, and sealing elements, e.g. ring seals, and damping elements.

The invention further provides mouldings obtainable from the rubber mixture according to the invention, via vulcanization.

The dynamic properties of the rubber mixtures according to the invention are advantageous.

### EXAMPLES

The following compounds are used in rubber mixtures:

3-Glycidyloxypropyltrimethoxysilane is obtainable as DYNASILAN GLYMO from EVONIK Industries.

3-Glycidyloxypropyltriethoxysilane is obtainable as DYNASILAN GLYEO from EVONIK Industries.

Aminopropyltriethoxysilane is obtainable as DYNASILAN AMEO from EVONIK Industries.

ASTM N 339 carbon black is obtainable as Corax N 339 from Orion Engineered Carbons.

ASTM N 660 carbon black is obtainable as Corax N 660 from Orion Engineered Carbons.

ASTM N 550 carbon black is obtainable as Corax N 550 from Orion Engineered Carbons.

### Example 1

### Rubber Mixtures

The parent formulation used for the rubber mixtures is given in Table 1 below. The unit phr here means proportions by weight, based on 100 parts of the crude rubber used.

The general process for producing rubber mixtures and vulcanizates of these is described in the following book: “Rubber Technology Handbook”, W. Hofmann, Hanser Verlag 1994.

TABLE 1
Formulation

| | Amount added |
|---|---|
| | [phr] |
| 1^{st} stage | |
| Hytemp AR 71 (ACM) | 100 |
| Struktol WB 222 | 2 |
| Rhenofit OCD-SG | 2 |
| Vulkanol 81 | 5 |
| Stearic acid | 2 |
| Filler | variable |
| Silane | isomolar |
| 2^{nd} stage | |
| Stage 1 batch | |
| Rhenofit Na stearate 80 | 3.5 |
| Sulphur | 0.4 |

The polymer Hytemp AR 71 involves a polyacrylate rubber with Mooney viscosity from 42 to 54 from Zeon Chemicals.

Ultrasil 360 is a silica from EVONIK Industries.

Struktol WB 222 is an anhydrous blend of high-molecular-weight, aliphatic fatty acid esters and condensates from Struktol Company of America, Rhenofit OCD-SG is an octylated diphenylamine from RheinChemie and Vulkanol 81 is a mixture of thioester and carboxylic ester from Lanxess. Rhenofit Na stearate 80 is Na stearate bonded on silica from RheinChemie.

The rubber mixtures are produced in an internal mixer in accordance with the mixing specification in Table 2.

TABLE 2
Stage 1

| | |
|---|---|
| Settings | |
| Mixing assembly | Werner & Pfleiderer E-type |
| Rotation rate | 90 min⁻¹ |
| Ram pressure | 5.5 bar |
| Capacity | 1.58 L |
| Fill level | 0.55 |
| Chamber temp. | 90° C. |
| Mixing procedure | |
| from 0 to 1 min | Polymer, silica, silane |
| from 1 to 5 min | Purge, stearic acid, Vulkanox, |
| | Vulkanol, Struktol |
| 5 min | Discharge, mix directly on roll |
| Batch temp. | 140-150° C. |
| Storage | — |

Stage 2

| | |
|---|---|
| Settings | |
| Mixing assembly | Roll (diameter 150 mm, length 350 mm) |
| Chamber temp. | 50° C. |
| Mixing procedure | |
| from 0 to 2 min | Stage 1 batch, form milled sheet and cool |
| from 2 to 8 min | Rhenofit, sulphur |
| | Cut the material 3 towards the left and 3 |
| | times towards the right and roll the material |
| | 3 times with narrow roll gap and 3 times |
| | with wide roll gap and draw off milled sheet. |
| Batch temp. | about 70° C. |

Vulcanization takes place at 160° C. for 30 min. and this is followed by conditioning at 180° C. for 2 hours.

Table 3 collates the methods for rubber testing.

TABLE 3

| Physical testing | Standard/conditions |
|---|---|
| ML 1 + 4, 100° C., 3^{rd} stage | DIN 53523/3, ISO 667 |
| RPA | Strainsweep: T = 60° C., minimum |
| | elongation = 0.28%, maximum |
| | elongation = 42%, |
| | frequency: 1.6 Hz |
| MDR | DIN 53529/3, ISO 6502 |
| Shore A hardness, 23° C. (SH) | DIN 53 505 |
| Tear-propagation resistance | DIN ISO 34 |
| DIE B | |

Tables 4a and 4b show the results from the vulcanizates.

TABLE 4a

| | | Inv. | Reference | Inv. | Reference | Inv. | Reference | Inv. | Reference | Reference |
|---|---|---|---|---|---|---|---|---|---|---|
| Filler/silane | | mixture 1 | mixture 1 | mixture 2 | mixture 2 | mixture 3 | mixture 3 | mixture 4 | mixture 4 | mixture 5 |
| Filler | | ULTRASIL | ULTRASIL | ULTRASIL | ULTRASIL | ULTRASIL | ULTRASIL | ULTRASIL | CORAX | CORAX |
| | | 360 | 360 | 360 | 360 | 360 | 360 | 360 | N 339 | N 660 |
| Amount of filler | phr | 50 | 50 | 50 | 40 | 40 | 30 | 30 | 50 | 50 |
| Silane | | GLYMO | AMEO | GLYEO | AMEO | GLYEO | AMEO | GLYEO | — | — |
| Amount of silane | phr | 3.20 | 3.00 | 3.80 | 2.40 | 3.04 | 1.80 | 2.28 | — | — |
| ML(1 + 4) at | MU | 40 | 86 | 41 | 84 | 37 | 77 | 35 | 65 | 43 |
| 100° C. 1^{st} stage | | | | | | | | | | |
| ML(1 + 4) at | MU | 38 | 85 | 41 | 78 | 38 | 73 | 35 | 62 | 41 |
| 100° C. 2^{nd} stage | | | | | | | | | | |
| Mooney Scorch | | | | | | | | | | |
| Scorch Time t | min | 42.4 | 3.8 | 22.4 | 22.1 | 23.3 | 28.5 | 26.7 | 28.2 | 33.5 |
| MDR: | | | | | | | | | | |
| 165° C.; 0.5° | | | | | | | | | | |
| M_{L} | dNm | 1.3 | 2.7 | 1.4 | 3.8 | 1.1 | 2.6 | 0.9 | 2.8 | 1.5 |
| M_{H} | dNm | 8.8 | 14.0 | 11.0 | 12.4 | 8.6 | 9.9 | 5.3 | 12.2 | 8.1 |
| Delta torque | dNm | 7.5 | 11.2 | 9.6 | 8.6 | 7.5 | 7.3 | 4.4 | 9.4 | 6.6 |
| t 10% | min | 6.3 | 0.8 | 5.7 | 0.6 | 5.8 | 0.7 | 5.6 | 4.2 | 4.9 |
| t 20% | min | 10.9 | 1.3 | 9.2 | 1.3 | 9.4 | 1.5 | 9.6 | 8.2 | 8.0 |
| t 90% | min | 47.0 | 9.8 | 41.2 | 24.4 | 42.7 | 23.8 | 46.1 | 41.9 | 40.8 |
| t 80% − t 20% | min | 27.5 | 5.6 | 23.0 | 14.3 | 23.9 | 13.9 | 27.2 | 24.3 | 23.2 |

TABLE 4b

| | | Inv. | Reference | Inv. | Reference | Inv. | Reference | Inv. | Reference | Reference |
|---|---|---|---|---|---|---|---|---|---|---|
| Filler/silane | | mixture 1 | mixture 1 | mixture 2 | mixture 2 | mixture 3 | mixture 3 | mixture 4 | mixture 4 | mixture 5 |
| Filler | | ULTRASIL | ULTRASIL | ULTRASIL | ULTRASIL | ULTRASIL | ULTRASIL | ULTRASIL | CORAX | CORAX |
| | | 360 | 360 | 360 | 360 | 360 | 360 | 360 | N 339 | N 660 |
| Amount | phr | 50 | 50 | 50 | 40 | 40 | 30 | 30 | 50 | 50 |
| of filler | | | | | | | | | | |
| Silan | | GLYMO | AMEO | GLYEO | AMEO | GLYEO | AMEO | GLYEO | — | — |
| Amount | phr | 3.20 | 3.00 | 3.80 | 2.40 | 3.04 | 1.80 | 2.28 | — | — |
| of silane | | | | | | | | | | |

RPA strainsweep 28% - 42% - crude material

| | | | | | | | | | | |
|---|---|---|---|---|---|---|---|---|---|---|
| Max. shear | [MPa] | 0.42 | 0.6 | 0.43 | 0.64 | 0.34 | 0.45 | 0.27 | 1.28 | 0.52 |
| modulus | | | | | | | | | | |
| Min. shear | [MPa] | 0.2 | 0.3 | 0.21 | 0.34 | 0.19 | 0.27 | 0.17 | 0.25 | 0.19 |
| modulus | | | | | | | | | | |
| Max loss | — | 0.390 | 0.317 | 0.384 | 0.295 | 0.347 | 0.291 | 0.311 | 0.428 | 0.354 |
| factor tan(d) | | | | | | | | | | |
| Loss factor | — | 0.276 | 0.193 | 0.277 | 0.179 | 0.256 | 0.178 | 0.240 | 0.383 | 0.287 |
| tan(d) at 7% | | | | | | | | | | |

RPA strainsweep 28% - 100% - vulcanizate

| | | | | | | | | | | |
|---|---|---|---|---|---|---|---|---|---|---|
| Max. shear | [MPa] | 0.77 | 1.34 | 0.79 | 1.1 | 0.58 | 0.8 | 0.39 | 2.85 | 0.86 |
| modulus | | | | | | | | | | |
| Min. shear | [MPa] | 0.53 | 1.04 | 0.61 | 0.67 | 0.46 | 0.48 | 0.29 | 0.55 | 0.36 |
| modulus | | | | | | | | | | |
| Max loss | — | 0.086 | 0.150 | 0.068 | 0.175 | 0.083 | 0.172 | 0.074 | 0.300 | 0.157 |
| factor tan(d) | | | | | | | | | | |
| Loss factor | — | 0.077 | 0.051 | 0.052 | 0.058 | 0.048 | 0.049 | 0.058 | 0.277 | 0.149 |
| tan(d) at 7% | | | | | | | | | | |

In the case of the aminosilane, the milled sheet obtained after vulcanization was poor, and was almost “crumbly” in some cases.

Except for the dynamic data, the vulcanizate data for the mixtures with epoxysilane are similar to those for the mixtures with carbon black. The ideal elongation at break is achieved by using 40 phr of silica. However, very clear advantages are apparent for the epoxysilane-containing mixtures in comparison with mixtures with carbon black in the ball-rebound test and in the tan δ in the RPA testing of the vulcanizates. 50% improvement in comparison to N 339, and 20% improvement in comparison with N 660, are achieved in the ball-rebound test.

### Example 2

### Rubber Mixtures

Table 5 gives the parent formulation used for the rubber mixtures. The unit phr here means proportions by weight, based on 100 parts of the crude rubber used.

TABLE 5
Formulation

| | Amount added |
|---|---|
| | [phr] |
| 1st stage | |
| Hytemp AR 71 (ACM) | 100 |
| Struktol WB 222 | 2 |
| Rhenofit OCD-SG | 2 |
| Vulkanol 81 | 5 |
| Stearic acid | 2 |
| Filler | variable |
| Silane | isomolar |
| 2nd stage | |
| Stage 1 batch | |
| Rhenofit Na stearate 80 | 3.5 |
| Sulphur | 0.4 |

The chemicals are specified in Example 1.

The following carbon blacks commonly used in the rubber industry: N339, N550 and N660. The rubber mixtures are produced in an internal mixer in accordance with the mixing specification in Table 6.

TABLE 6
Stage 1

| | |
|---|---|
| Settings | |
| Mixing assembly | Harburg-Freudenberger GK 0.3E |
| | internal mixer |
| Rotation rate | 75 min⁻¹ |
| Ram pressure | 5 bar |
| Capacity | 0.3 L |
| Fill level | 0.8 |
| Chamber temp. | 70° C. |
| Mixing procedure | |
| from 0 to 1 min | Polymer, silica, silane |
| from 1 to 6 min | Stearic acid, Vulkanox, Vulkanol, |
| | Struktol (aerate twice) |
| 6 min | Discharge, roll the material twice |
| | directly on the roll and draw off |
| | milled sheet |
| Batch temp. | 140-150° C. |
| Storage | — |

Stage 2

| | |
|---|---|
| Settings | |
| Mixing assembly | Harburg-Freudenberger GK 0.3E |
| | internal mixer |
| Rotation rate | 25 min⁻¹ |
| Ram pressure | 5 bar |
| Capacity | 0.3 L |
| Fill level | 0.9 |
| Chamber temp. | 50° C. |
| Mixing procedure | |
| from 0 to 1 min | Stage 1 batch |
| from 1 to 3 min | Rhenofit, sulphur |
| | Discharge, roll material 3 times directly |
| | on the roll and draw off milled sheet |
| | Roll material 3 times with wide roll gap |
| | Draw off milled sheet. |
| Batch temp. | about 80° C. |

Vulcanization takes place at 160° C. for 30 min. and this is followed by conditioning at 180° C. for 2 hours.

Table 7 collates the methods for rubber testing.

TABLE 7

| Physical testing | Standard/conditions |
|---|---|
| ML 1 + 4, 100° C., 3^{rd} stage | DIN 53523/3, ISO 667 |
| DMA | Temperature sweep: T = from −60° C. |
| | to 160° C., frequency: 10 Hz |
| MDR | DIN 53529/3, ISO 6502 |
| Shore A hardness, 23° C. (SH) | DIN 53 505 |
| Tensile test | DIN 53 504 |
| Rebound resilience | DIN 53 512 |

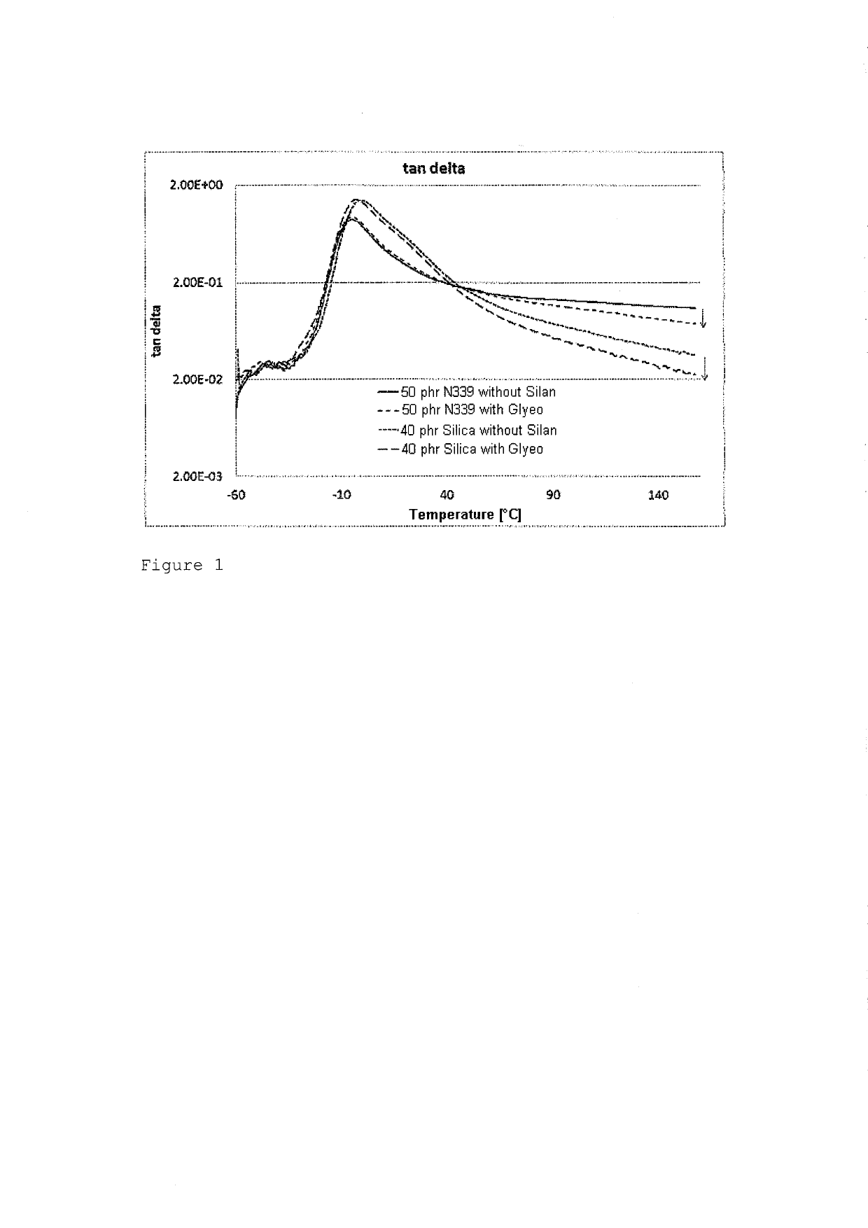

Table 8 and FIG. 1 (temperature dependency of tan δ) show the results from the vulcanizates.

TABLE 8

| | | | Inv. | Reference | Inv. | Inv. | Inv. | Reference | Reference | Reference |
|---|---|---|---|---|---|---|---|---|---|---|
| | | | mixture 5 | mixture 6 | mixture 6 | mixture 7 | mixture 8 | mixture 7 | mixture 8 | mixture 9 |
| Filler | | | ULTRASIL | ULTRASIL | CORAX | CORAX | CORAX | CORAX | CORAX | CORAX |
| | | | 360 | 360 | N 339 | N 550 | N 660 | N 339 | N 550 | N 660 |
| Amount of filler | phr | | 40 | 40 | 50 | 50 | 50 | 50 | 50 | 50 |
| Silane | | | GLYEO | — | GLYEO | GLYEO | GLYEO | — | — | — |
| Amount of | phr | | 3.04 | — | 3.8 | 3.8 | 3.8 | — | — | — |
| silane | | | | | | | | | | |
| ML (1 + 4) | MU | 100° C. | 47.6 | 35.7 | 59.4 | 43.3 | 40.7 | 56.2 | 46.8 | 41.3 |
| ML | dNm | | 2.03 | 1.25 | 2.41 | 1.65 | 1.47 | 2.65 | 1.89 | 1.60 |
| MH | dNm | | 9.51 | 8.78 | 11.78 | 7.45 | 7.25 | 8.54 | 6.40 | 5.76 |
| MH − ML | dNm | 160° C. | 7.48 | 7.53 | 9.37 | 5.80 | 5.78 | 5.89 | 4.51 | 4.16 |
| | | 60 minutes | | | | | | | | |
| t10 | min | | 6.96 | 1.97 | 2.19 | 5.02 | 4.60 | 1.60 | 5.51 | 5.02 |
| t90 | min | | 47.76 | 38.26 | 46.13 | 46.11 | 44.27 | 48.36 | 47.32 | 47.37 |
| Rebound res. | at 60° C. | | 59.2 | | 42.6 | 47.8 | 53 | 36.2 | 47 | 48.8 |
| Rebound res. | | at room | 8.8 | 6 | 8.4 | 8.3 | 8.9 | 7.6 | 7.6 | 7.4 |
| | | temperature | | | | | | | | |
| Shore | | | 50 | 46 | 60 | 53 | 50 | 57 | 50 | 47 |
| Tensile test, | σR | N/mm² | 10.1 | 9.6 | 14.5 | 12.2 | 11.7 | 12.6 | 10 | 9.1 |
| specimen, | εR | % | 282.6 | 406.6 | 396.7 | 393.8 | 385.3 | 496.6 | 467.3 | 487.8 |
| longitudinal | σ050 | N/mm² | 0.9 | 0.6 | 1.2 | 1 | 0.9 | 0.9 | 0.7 | 0.6 |
| | σ100 | N/mm² | 2.5 | 1.2 | 2.3 | 2.4 | 2.2 | 1.4 | 1.6 | 1.2 |
| | σ200 | N/mm² | 7.3 | 3.3 | 6.9 | 7.3 | 6.9 | 3.7 | 4.6 | 3.4 |
| | σ300 | N/mm² | | 5.9 | 11.6 | 10.6 | 10 | 7.1 | 7.3 | 5.7 |
| | σ400 | N/mm² | | 9.25 | 14.5 | 12.28 | | 10.17 | 9.17 | 7.65 |

Comparison of the carbon black mixtures with Glyeo epoxysilane and without silane reveals markedly higher rebound resilience at 60° C. for the mixtures with Glyeo. The tan δ shown for the carbon black mixture with silane in FIG. 1 is also markedly lower than that of the mixtures without silane. This tendency is most pronounced for N 339 carbon black.

1. A rubber mixture, comprising:
(A) at least one polyacrylate rubber;
(B) at least one silicatic or oxidic filler or carbon black; and
(C) at least one epoxysilane.

2. The rubber mixture according to claim 1, wherein the epoxysilane is an epoxysilane of the formula I 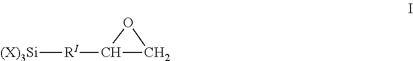
where
X is mutually independently an alkylpolyether group O—((CR^{II}₂)_{w}—O—)ₜAlk,
branched or unbranched alkyl,
branched or unbranched alkoxy,
branched or unbranched C₂-C₂₅ alkenyloxy,
C₆-C₃₅ aryloxy,
a branched or unbranched C₇-C₃₅ alkylaryloxy group, or a branched or unbranched C₇-C₃₅ aralkyloxy group,
where R^{II} are mutually independently H, a phenyl group or an alkyl group,
w=from 2 to 20,
t=from 2 to 20,
Alk is a branched or unbranched, saturated or unsaturated, substituted or unsubstituted, aliphatic, aromatic or mixed aliphatic/aromatic monovalent hydrocarbon group having more than 6 carbon atoms, and,
R¹ is a branched or unbranched, saturated or unsaturated, aliphatic, aromatic or mixed aliphatic/aromatic divalent C₁-C₃₀ hydrocarbon group which optionally has substitution, or a divalent alkyl ether group.

3. The rubber mixture according to claim 2, wherein the epoxysilane has the general formula I
(C₂H₅O)₃Si(CH₂)₃—O—CH₂—CH(O)CH₂,
(CH₃O)₃Si(CH₂)₃—O—CH₂—CH(O)CH₂,
(C₃H₇O)₃Si(CH₂)₃—O—CH₂—CH(O)CH₂,
(CH₃)(C₂H₅O)₂Si(CH₂)₃—O—CH₂—CH(O)CH₂,
(CH₃)₂(C₂H₅O)Si(CH₂)₃—O—CH₂—CH(O)CH₂,
(CH₃)(CH₃O)₂Si(CH₂)₃—O—CH₂—CH(O)CH₂,
(CH₃)₂(CH₃O)Si(CH₂)₃—O—CH₂—CH(O)CH₂,
(C₂H₅O)₃Si—CH₂—O—(CH₂)₃—CH(O)CH₂,
(CH₃O)₃Si—CH₂—O—(CH₂)₃—CH(O)CH₂,
(C₃H₇O)₃Si—CH₂—O—(CH₂)₃—CH(O)CH₂,
(CH₃)(C₂H₅O)₂Si—CH₂—O—(CH₂)₃—CH(O)CH₂,
(CH₃)₂(C₂H₅O)Si—CH₂—O—(CH₂)₃—CH(O)CH₂,
(CH₃)(CH₃O)₂Si—CH₂—O—(CH₂)₃—CH(O)CH₂ or
(CH₃)₂(CH₃O)Si—CH₂—O—(CH₂)₃—CH(O)CH₂.

4. The rubber mixture according to claim 2 wherein the epoxysilane is a mixture of epoxysilanes of the general formula I.

5. The rubber mixture according to claim 1, wherein the epoxysilane has been absorbed onto an inert organic or inorganic carrier or has been pre-reacted with an organic or inorganic carrier.

6. The rubber mixture according to claim 1, comprising an additional silane.

7. The rubber mixture according to claim 1, further comprising:
(D) a thiuram sulphide accelerator and/or carbamate accelerator and/or the corresponding zinc salts,
(E) optionally a nitrogen-containing co-activator,
(F) optionally further rubber auxiliaries, and
(G) optionally further accelerators.

8. Process for producing the rubber mixture according to claim 1, comprising mixing together at least one polyacrylate rubber, at least one silicatic or oxidic filler or carbon black, and at least one epoxysilane.

9. A process producing a molding, comprising subjecting the rubber mixture according to claim 1 to a molding step.

10. A rubber article, comprising the rubber mixture according to claim 1.

11. The rubber article of claim 10 wherein the article is selected from the group comprising an air spring, a pneumatic tire, a non-pneumatic tire, a tire tread, a cable sheathing, a hose, a drive belt, a conveyor belt, a roll covering, a shoe sole, a sealing ring and a damping element.

12. The rubber mixture according to claim 3 wherein the epoxysilane is a mixture of epoxysilanes of the general formula I.
